(19) United States
(12) Patent Application Publication
(10) Pub. No.: US 2025/0018236 A1
(43) Pub. Date: Jan. 16, 2025

(54) Locking Bracket

(71) Applicant: Victaulic Company, Easton, PA (US)

(72) Inventors: Brian Sloan, Easton, PA (US); Nicholas Leasure, Easton, PA (US); Craig Haney, Nazareth, PA (US)

(21) Appl. No.: 18/765,695

(22) Filed: Jul. 8, 2024

Related U.S. Application Data
(60) Provisional application No. 63/512,748, filed on Jul. 10, 2023.

(51) Int. Cl. A62C 35/68; F16M 13/02

(52) U.S. Cl. CPC A62C 35/68; F16M 13/027

(57) ABSTRACT

A bracket uses a base and a locking body to attach an element to a structure. The base is attachable to the structure and defines an aperture for receiving the element. The locking body defines an opening adapted to receive the element. The locking body defines an engagement surface positioned within the opening. The engagement surface is adapted to secure the element to the base through mechanical engagement. The locking body is movable between a first position wherein the opening is not aligned with the aperture, and a second position wherein the opening aligns with the aperture. The engagement surface is engagable with the element when the locking body is in the second position.

### CROSS REFERENCE TO RELATED APPLICATIONS

This application is based upon and claims benefit of priority to U.S. Provisional Application No. 63/512,748, filed Jul. 10, 2023, which is hereby incorporated by reference herein.

### FIELD OF THE INVENTION

The invention concerns a bracket for attaching an element to a structure.

### BACKGROUND

FIG. 1 shows an example assembly 10 according to the prior art wherein a bracket 12 is used to attach an element 14 to a support 16. In this example, the assembly 10 is a fire suppression sprinkler system for a specialty ceiling, such as a ceiling in a cleanroom, comprising a heat triggered sprinkler 26 attached to a long tube 18, or sprinkler reducer, extending through ceiling grid members 20. Typically, a gasket 24 seals the lower end of the long tube 18 to a ceiling member. The upper end of the long tube 18 is connected to a flexible hose 28 attached to a branch pipe of the fire suppression system (not shown). A bracket 12 is attached to the long tube 18 via a retaining ring secured within a groove that is located at a predetermined, fixed location on the long tube 18. The bracket 12 bolts to the top 22 of ceiling grid members 20 to locate and secure the long tube 18. Ceiling grid members 20 of different ceiling grid systems have different heights requiring different lengths L between the gasket 24 and the location of the bracket 12. Because the required length L is different depending on the type of ceiling grid system, different long tubes 18 having different lengths L and different locations of the groove to secure the retaining ring and bracket 12 must be available. Alternative means for attaching the long tube 18 to the ceiling grid members 20 at the necessary height may require multiple components, such as multiple retaining rings or snap rings, and tools to adjust the location of the components in the field. There is clearly a need for a bracket that simplifies and permits adjustment from the lower end of the long tube to the location where the bracket secures the long tube to the structure to accommodate different ceiling grid systems.

### SUMMARY

An example bracket according to the disclosure is adapted to attach an element to a structure. The bracket comprises a base attachable to the structure and defines an aperture for receiving the element. A locking body defines an opening adapted to receive the element. The locking body defines an engagement surface positioned within the opening. The engagement surface is adapted to secure the element to the base. The locking body is movable between a first position wherein the opening is not aligned with the aperture and a second position wherein the opening aligns with the aperture. The engagement surface is engagable with the element when the locking body is in the second position.

In an example embodiment, the aperture has a circular shape. In a further example embodiment, at least a portion of the engagement surface has a radius smaller than a radius of the aperture.

In an example embodiment, the aperture extends through the base to define a slot. In a further example embodiment, the slot comprises a curved recess. In a further example embodiment, at least a portion of the engagement surface has a radius equal to a radius of the curved recess.

In an example embodiment, the base comprises a first lobe and a second lobe extending from the base on opposite sides of the aperture. In a further example embodiment, the first and second lobes extend along a common center line. In a further example embodiment, the base further comprises a first hole defined by the first lobe and a second hole defined by the second lobe. A first fastener is received in the first hole, and a second fastener is received in the second hole. The first and second fasteners are adapted to attach the bracket to the structure.

In a further example embodiment, the locking body comprises first and second lobes extending from opposite sides of the opening. In a further example embodiment, the first and second lobes of the locking body extend along a common center line. In a further example embodiment, the locking body further comprises a first hole defined by the first lobe of the locking body, and a second hole defined by the second lobe of the locking body. When the locking body is moved into the second position such that the opening in the locking body aligns with the aperture in the base, the first hole of the locking body aligns with the first hole of the base and the second hole of the locking body aligns with the second hole of the base.

In an example embodiment, the locking body is pivotably attached to the base. In a further example embodiment, the bracket further comprises an axle extending through the locking body and the base. The axle defines a pivot axis for pivoting of the locking body relative to the base.

In an example embodiment, the locking body is slidable relative to the base.

In an example embodiment, the locking body and the base have at least one corresponding projection.

In an example embodiment, the opening is U-shaped.

In an example embodiment, the locking body comprises a tab extending therefrom. In a further example embodiment, the tab is located proximate to the opening.

In an example embodiment, the engagement surface comprises at least a portion of a perimeter defining the opening.

In an example embodiment, the locking body comprises a dimple and the base comprises a recess configured to receive the dimple.

An example combination of an element and a bracket for mounting the element to a structure is disclosed. The bracket of the combination comprises a base attachable to the structure and defining an aperture for receiving the element. A locking body defines an opening adapted to receive the element. The locking body defines an engagement surface positioned within the opening. The engagement surface is adapted to secure the element to the base. The locking body is movable between a first position wherein the opening is not aligned with the aperture and a second position wherein the opening aligns with the aperture. The engagement surface is engagable with the element when the locking body is in the second position.

In an example embodiment, the element defines at least one recess.

In an example embodiment, the engagement surface comprises at least a portion of a perimeter defining the opening. In a further example embodiment, the radius of the portion of the opening is larger than a radius at the recess and smaller than the outer radius of the tube. In a further example embodiment, the portion of the perimeter is receivable into a recess of the at least one recess.

In an example embodiment the element is a tube.

In a further example embodiment, the aperture comprises a radius larger than an outer radius of the tube.

In a further example embodiment, at least a portion of the opening has a radius smaller than the radius of the aperture.

In a further example embodiment, the aperture comprises a radius of at least one recess of the at least one recess and smaller than an outer radius of the tube.

In an example embodiment, the opening is U-shaped

An example method of securing an element to a structure by a bracket according to the invention comprises positioning an element within an aperture defined by a base. The method comprises moving a locking body from a first position to a second position. The locking body defines an opening adapted to receive the element. The locking body defines an engagement surface positioned within the opening. The engagement surface is adapted to secure the element to the base. The opening is not aligned with the aperture in the first position. The opening aligns with the aperture and the engagement surface engages with the element when the locking body is in the second position.

### BRIEF DESCRIPTION OF THE DRAWINGS

FIG. 1 is an isometric view of a bracket used in an assembly to attach an element to a structure according to the prior art;

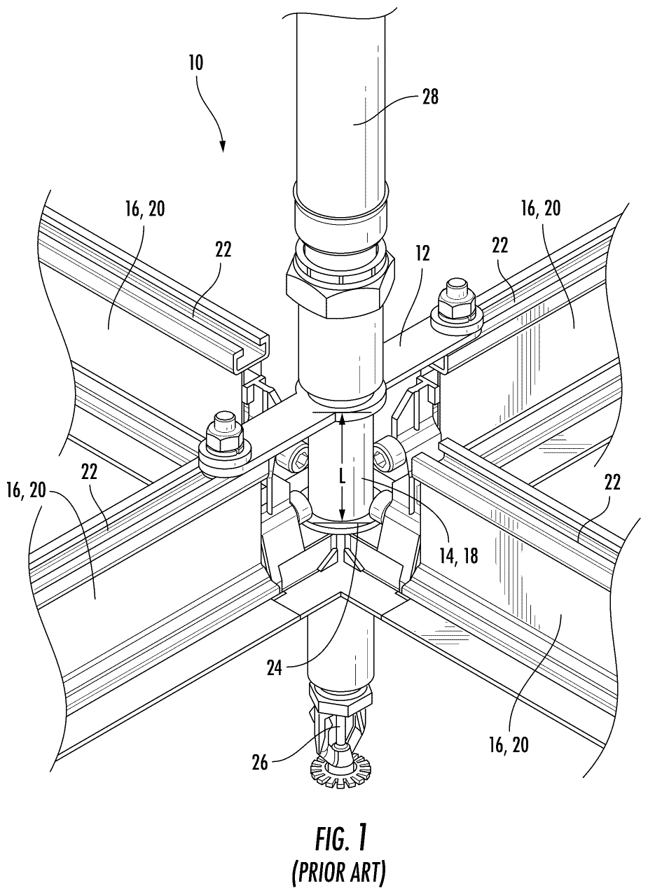

FIG. 2 is an isometric view of an example combination of a bracket and element positioned on a structure according to the invention;

FIG. 3 is an isometric view of the combination bracket and element shown in FIG. 2;

FIG. 3A is an isometric view of an example bracket in a first position;

FIG. 3B is an isometric view of an example bracket in a first position;

FIG. 4 is an isometric view of the example combination of bracket and element positioned on the structure as shown in FIG. 2 with the element secured by the bracket;

FIG. 4A is an isometric view of the example bracket shown in FIG. 3A in a second position;

FIG. 4B is an isometric view of the example bracket shown in FIG. 3B in a second position;

FIG. 5 is a side view of the combination bracket and element shown in FIG. 3 with the locking body shown in the second position;

FIG. 5A is a side view of a combination bracket shown in FIG. 3A or 3B and element with the locking body shown in the second position;

FIG. 6 is a section view along line 6-6 in FIG. 5; and

FIG. 6A is a section view along line 6A-6A in FIG. 5A.

### DETAILED DESCRIPTION

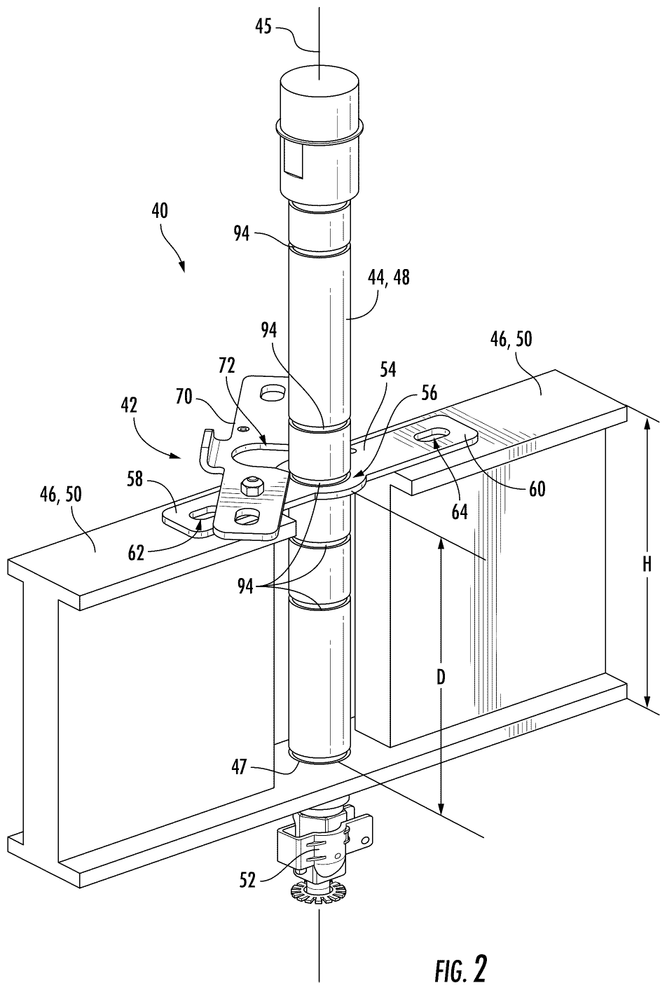

FIG. 2 shows an example combination 40 according to the invention comprising a bracket 42 and an element 44. The bracket 42 is adapted to attach the element 44 to a structure 46. In this example, the bracket 42 is adapted to attach a tube 48 to cross members 50 of a ceiling grid. The tube 48 may act as a sprinkler reducer and may be attached to a heat triggered sprinkler 52. In a specific embodiment, the cross members 50 may be used to support a cleanroom ceiling.

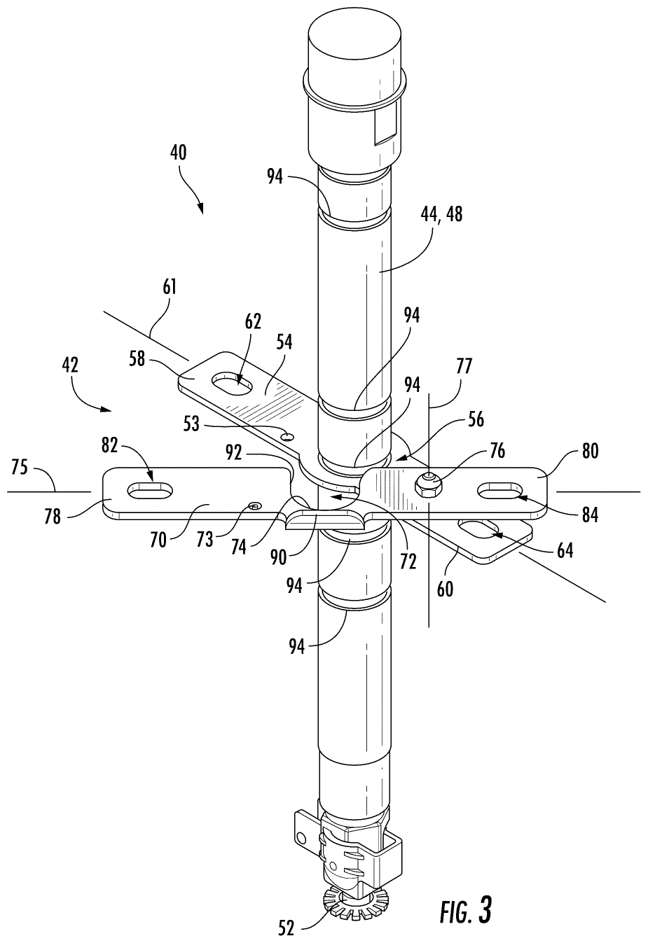

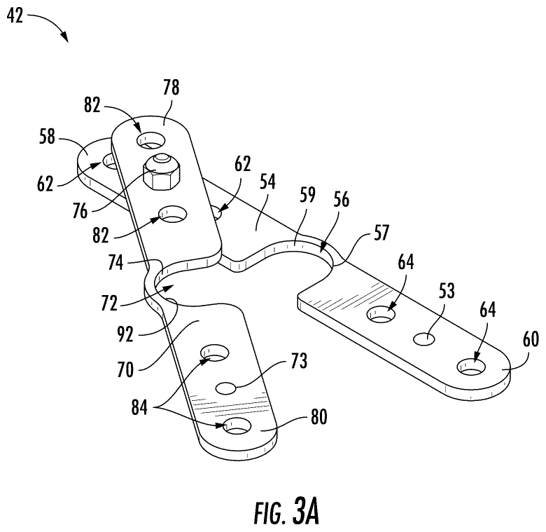

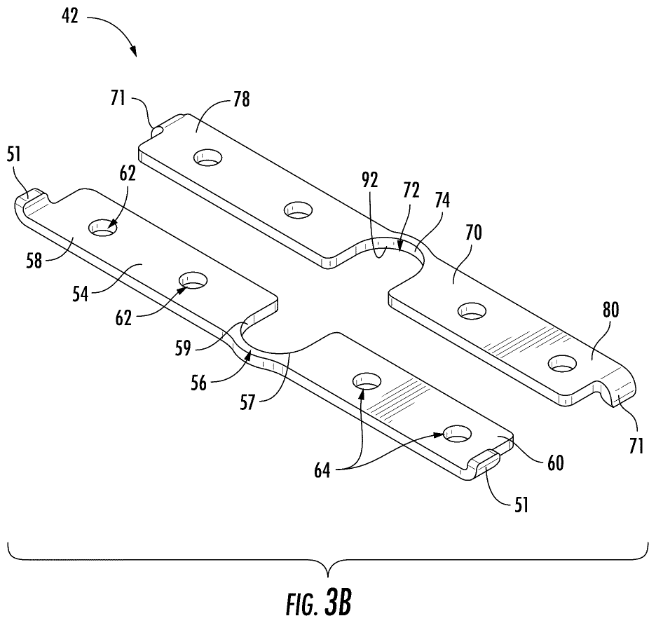

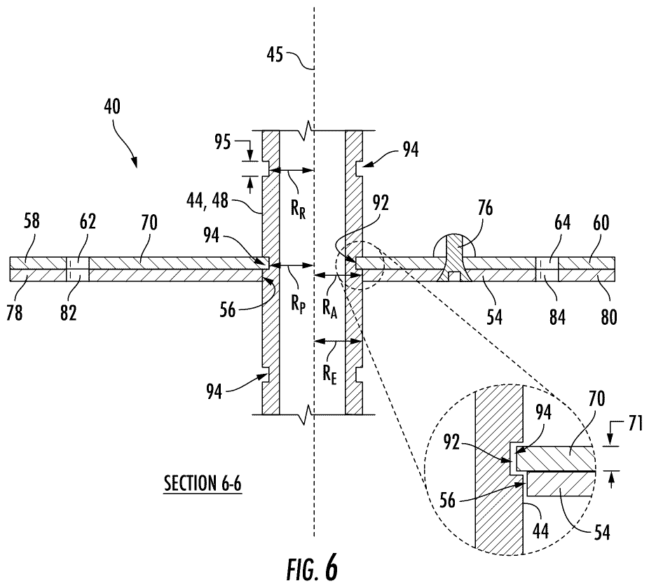

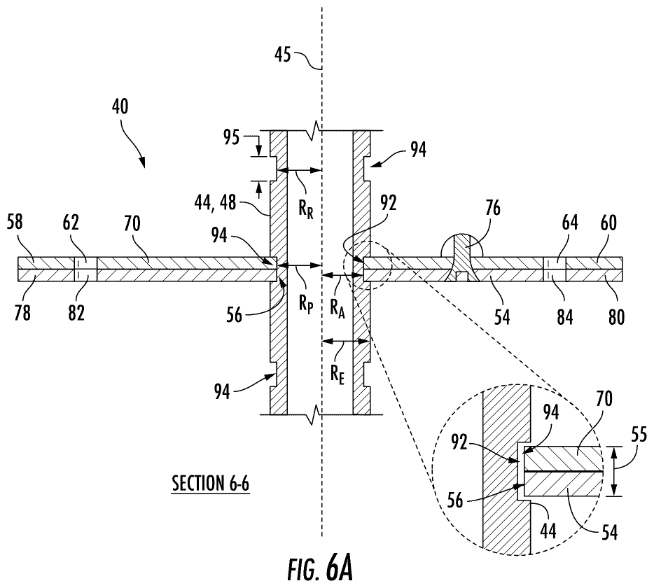

The bracket 42 comprises a base 54 attachable to the structure 46. In this example, the base 54 is a steel plate. The base 54 defines an aperture 56 for receiving the element 44. Optionally, as shown in the example bracket 42 in FIG. 3, the aperture 56 is shaped to receive and surround the tube 48 (such as the circular aperture 56 shown). Alternatively, with reference to FIGS. 3A and 3B, the aperture 56 may extend through the base 54 to define a slot 57. As shown in FIGS. 3A and 3B, the slot 57 may comprise a shape that only partially surrounds the tube, such as a curved recess 59. The curved recess 59 may comprise a partial circle (e.g., a surface having a consistent radius). In exemplary configurations, the curved recess 59 of the slot 57 can subtend an angle from 120 degrees to 240 degrees or from 160 degrees to 200 degrees. With reference to FIGS. 6 and 6A, the aperture 56 has a radius RA.

As shown in FIGS. 2, 4, 5, 5A, 6, and 6A, base 54 and locking body 70 cooperate to secure an element 44 to a structure 46 by selectively engaging any one of recesses 94 in element 44. In certain embodiments, as shown (for example) in FIGS. 2, 3, and 6, the aperture 56 in base 54 may have a radius RA larger than the radius RE of the element 44, in this example the tube 48, to allow the element 44 to freely move along a first axis 45 within the aperture 56. As shown in FIG. 2, a distance D between the location where the bracket 42 secures the element 44 to the structure 46 and a location where a lower portion 47 of the element 44 extends through the structure 50 may be adjusted when the element 44 is free to move, thereby allowing the distance D to be adjusted to accommodate different heights H of the structure 46. The distance D may be incrementally adjusted according to the locations of a plurality of recesses 94 positioned along the element 44. In this example, the tube 48 may be moved along the first axis 45 to properly position the sprinkler 52 with respect to the cross members 50. Alternatively, and as shown in FIGS. 3A and 3B (for example), aperture 56 may define a slot 57 that may have a radius RA larger than the radius RE of the element 44, in this example the tube 48, to similarly allow the element 44 to freely move along a first axis 45 within the aperture 56.

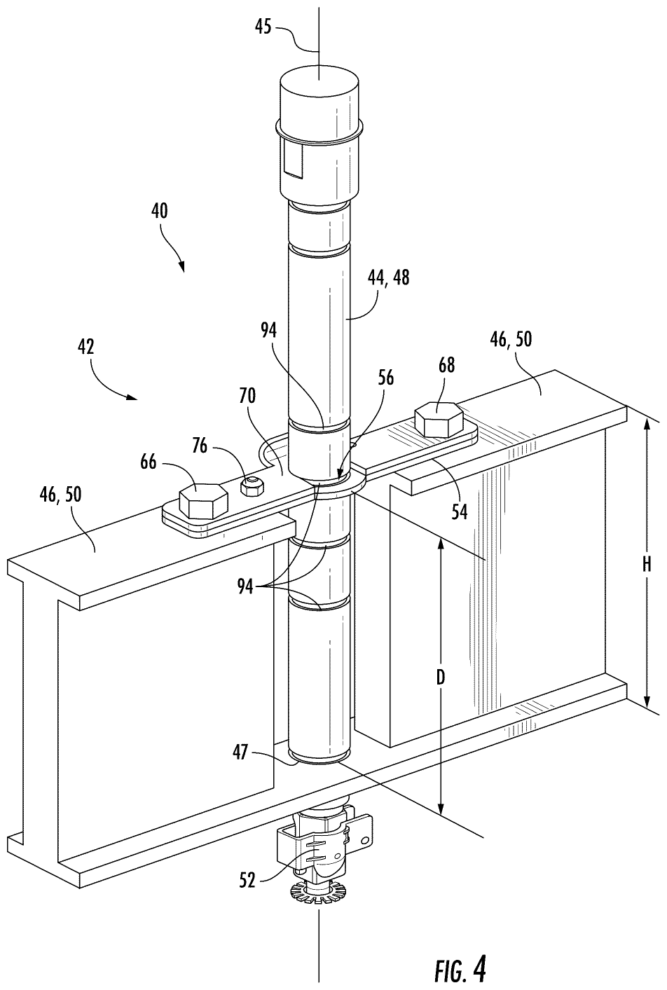

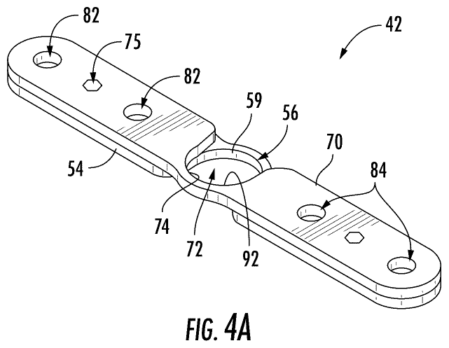

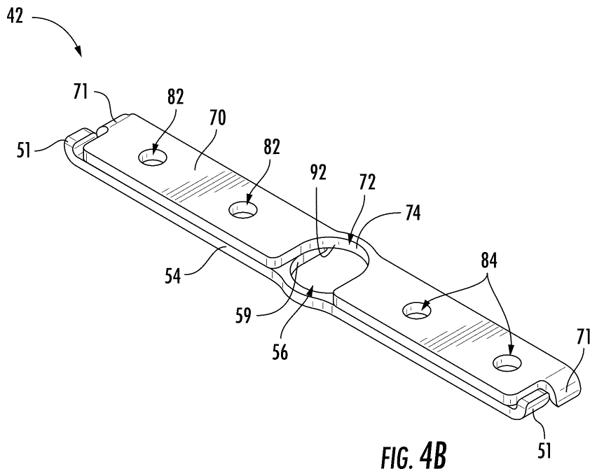

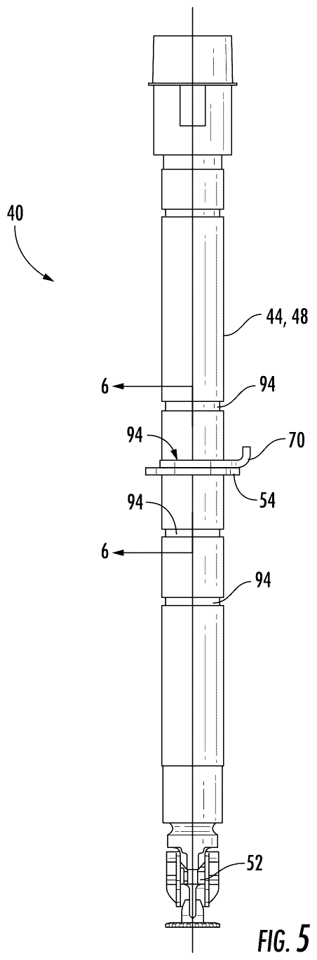

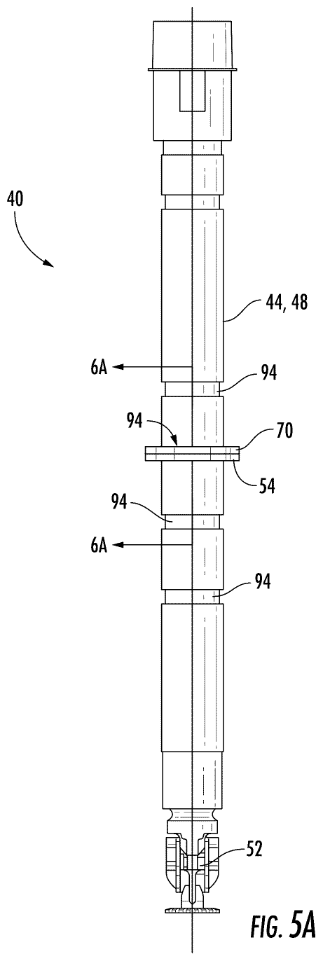

In another embodiment, as best shown in FIG. 6A, the aperture 56 defining slot 57 may have a radius RA that is larger than or equal to the radius RR of each recess of the plurality of recesses 94 positioned along the element 44 and smaller than the radius RE of the element 44 (in this example the tube 48) to allow mechanical engagement to secure the element 44 to the base 54 and ultimately to the structure 46 (e.g., cross member 50). The element 44 may be located along a first axis 45 prior to mechanically engaging the base 54 with a recess 94 positioned along the element 44, with the base 54 defining the aperture 56 having a radius RA smaller than the radius RE of the element 44. With reference to FIG. 4, the distance D between the location where the bracket 42 secures the element 44 to the structure 46 and a location where a lower portion 47 of the element 44 extends through the structure 50 may be adjusted when the element 44 is free to move, such as, in the example shown in FIGS. 5A and 6A, prior to positioning a recess 94 of the element 44 within the slot 57 of the base 54.

As shown in FIGS. 2-3B, the bracket 42 may further comprise a first lobe 58 and a second lobe 60 extending from the base 54 on opposite sides of the aperture 56. The first and second lobes 58, 60 provide a surface area to mount and secure the base 54 to the structure 46. The first and second lobes 58, 60 may extend along a common center line 61 to allow the bracket 42 to span across a space between two opposing cross members 50. The bracket 42 may further comprise at least one first hole 62 defined by the first lobe 58 and at least one second hole 64 defined by the second lobe 60. Optionally, in some configurations, and as shown in FIGS. 3A-3B, the at least one first hole 62 can comprise a plurality of axially spaced holes, and the at least one second hole 64 can comprise a plurality of axially spaced holes. As shown in FIG. 4, each hole of the at least one first hole 62 may receive a first fastener 66 and each hole of the at least one second hole 64 may receive a second fastener 68 to attach the base 54 to the structure 46.

A locking body 70 defines an opening 72 adapted to receive the element 44. In this example, the locking body 70 is a second steel plate and the opening 72 is generally U-shaped. Similarly to slot 57, the U-shaped opening may be a shape that only partially surrounds the tube, such as a curved recess, including a curved recess that is a partial circle (e.g., a surface having a consistent radius). The locking body 70 defines an engagement surface 74 positioned within the opening 72 to secure the element 44 to the base 54. The locking body 70 is movable between a first position (shown in FIGS. 2 and 3-3B), wherein the opening 72 is not aligned with the aperture 56 and the engagement surface 74 does not secure the element 44 to the base 54, thereby allowing the element 44 to freely move along the first axis 45, and a second position (shown in FIGS. 4-6), wherein the engagement surface 74 secures the element 44 to the base 54 thereby locking the element 44 in place. The locking body 70 may be pivotably attached to the base 54 to allow the locking body 70 to pivot between the first and second positions. Optionally, the locking body 70 is pivotably attached via an axle 76 extending through an opening 75 in the locking body 70 and the base 54 and defining a pivot axis 77 for pivoting the locking body 70 relative to the base 54. Advantageously, the locking body 70 may have a tab 90 extending therefrom and located proximate to the opening 72 to allow a user to pivot the locking body 70 by pushing or pulling the tab 90. Alternatively, as shown in FIGS. 3B and 4B, the locking body 70 may slide over top the base 54 until the opening 72 is aligned with the aperture 56. As shown in FIGS. 3B and 4B, the locking body 70 and the base 54 may have corresponding projections 51, 71 which mate or abut when the locking body 70 is in the second position (shown in FIG. 4B). The projections 51, 71 may provide a visual indication that the locking body 70 and the base 54 are properly positioned and aligned. In each embodiment herein, although the figures show the base 54 positioned between the structure 46 and the locking body 70, the positions of the base 54 and the locking body 70 may be interchangeable. For example, it is contemplated that the locking body 70 may be positioned between the structure 46 and the base 54.

As shown in FIGS. 4-6A, in the second position, the opening 72 aligns with the aperture 56 and the engagement surface 74 engages with the element 44 to secure the element 44 to the structure 46. In this example, the element 44 defines at least one recess 94 and the engagement surface 74 comprises at least a portion of a perimeter 92 defining the opening 72. The portion of the perimeter 92 is receivable into one of the recesses 94.

In some embodiments, as illustrated in FIG. 6, the portion of the perimeter 92 has a radius R_{P} larger than or equal to a radius R_{R} of the recess 94 and smaller than a radius R_{E} of the element 44 (in this example the tube 48) providing mechanical engagement to secure the element 44 to the base 54 and ultimately to the structure 46, cross member 50 (see FIG. 4). Optionally, the radius R_{A} of the aperture 56 in the base is larger than a radius R_{E} of the element 44 (in this example the tube 48). In these embodiments, recess 94 has a width 95 sized to receive only the thickness 71 of the locking body 70, and the locking body 70 has a thickness 71 that is less than the width 95 of recess 94 and sized to provide mechanical engagement thereto.

In some embodiments, as illustrated in FIG. 6A, both the radius R_{P} of the portion of the perimeter 92 of the opening 72 in the locking body 70 and the radius R_{A} of the aperture 56 defining a slot 57 in the base 54 (see FIGS. 3A-3B) are larger than or equal to a radius R_{R} of the recess 94 and smaller than a radius R_{E} of the element 44 (in this example the tube 48) to provide mechanical engagement to secure the element 44 to the locking body 70 and base 54 and ultimately to the structure 46. In these embodiments, recess 94 has a width 95 sized to receive the combined thickness of the locking body 70 and the base 54, and the locking body 70 and base 54 have a combined thickness 55 that is less than the width 95 of recess 94 in order to provide mechanical engagement thereto.

As shown in FIG. 3-3B, the locking body 70 may comprise first and second lobes 78, 80 extending from opposite sides of the opening 72. The first and second lobes 78, 80 of the locking body 70 may extend along a common center line 75. At least one first hole 82 may be defined by the first lobe 78 of the locking body 70, and at least one second hole 84 may be defined by the second lobe 80 of the locking body 70. For example, in some optional configurations as shown in FIGS. 3A-3B, the at least one first hole 82 can comprise a plurality of axially spaced holes, and the at least one second hole 84 can comprise a plurality of axially spaced holes. As shown in FIG. 4, each hole of the at least one first hole 82 may be configured to receive the first fastener 66, and each hole of the at least one second hole 84 may be configured to receive the second fastener 68 to secure both the base 54 and the locking body 70 to the structure 46. When the locking body 70 is pivoted or slid into the second position such that the opening 72 in the locking body 70 aligns with the aperture 56 in the base 54, each hole of the at least one first hole 82 of the locking body 70 aligns with a hole of the at least one first hole 62 of the base 54, and each hole of the at least one second hole 84 of the locking body 70 aligns with a hole of the at least one second hole 64 of the base 54. When a first hole 62 of the base 54 and a first hole 82 of the locking body 70 are aligned, the aligned first holes 62, 82 may receive the first fastener 66. When a second hole 64 of the base 54 and a second hole 84 of the locking body 70 are aligned, the aligned second holes 64, 84 may receive the second fastener 68. The fasteners 66, 68 secure the locking body 70 and base 54 to the structure 46 in the second position thereby securing the element 44 to the structure 46 at a desired distance D. As shown in FIGS. 3 and 3A, the locking body 70 may include a dimple 73. The dimple 73 may project from the locking body 70 towards the base 54. The base 54 may include a corresponding recess 53 configured to receive the dimple 73. The dimple 73 may nest in the recess 53 when the locking body 70 is pivoted into the second position to align and hold the locking body 70 to the base 54 before the fasteners 66, 68 secure the locking body 70 and base 54 to the structure 46.

It is expected that the example bracket 42 according to the invention will allow an element 44 to be adjustably secured to a structure 46.

All of the embodiments of the claimed invention described herein are provided expressly by way of example only. Innumerable variations and modifications may be made to the example embodiments described herein without departing from the concept of this disclosure. Additionally, the scope of this disclosure is intended to encompass any and all modifications and combinations of all elements, features, and aspects described in the specification and claims, and shown in the drawings. Any and all such modifications and combinations are intended to be within the scope of this disclosure.

What is claimed is:

1. A bracket adapted to attach an element to a structure, the bracket comprising:
a base attachable to the structure and defining an aperture for receiving the element; and
a locking body defining an opening adapted to receive the element, the locking body defining an engagement surface positioned within the opening, the engagement surface adapted to secure the element to the base, the locking body being movable between a first position wherein the opening is not aligned with the aperture, and a second position wherein the opening aligns with the aperture, the engagement surface being engagable with the element when the locking body is in the second position.

2. The bracket according to claim 1, wherein the aperture has a circular shape.

3. The bracket according to claim 2, wherein at least a portion of the engagement surface has a radius smaller than a radius of the aperture.

4. The bracket according to claim 1, wherein the aperture extends through the base to define a slot.

5. The bracket according to claim 4, wherein the slot comprises a curved recess.

6. The bracket according to claim 5, wherein at least a portion of the engagement surface has a radius equal to a radius of the curved recess.

7. The bracket according to claim 1, wherein the base comprises a first lobe and a second lobe extending from the base on opposite sides of the aperture.

8. The bracket according to claim 7, wherein the first and second lobes extend along a common center line.

9. The bracket according to claim 7, further comprising:
a first hole defined by the first lobe;
a second hole defined by the second lobe;
a first fastener received in the first hole; and
a second fastener received in the second hole; the first and second fasteners adapted to attach the bracket to the structure.

10. The bracket according to claim 9, wherein the locking body comprises first and second lobes extending from opposite sides of the opening.

11. The bracket according to claim 10, wherein the first and second lobes of the locking body extend along a common center line.

12. The bracket according to claim 10, wherein the locking body further comprises:
a first hole defined by the first lobe of the locking body; and
a second hole defined by the second lobe of the locking body; wherein
when the locking body is moved into the second position such that the opening in the locking body aligns with the aperture in the base, the first hole of the locking body aligns with the first hole of the base and the second hole of the locking body aligns with the second hole of the base.

13. The bracket according to claim 1, wherein the locking body is pivotably attached to the base.

14. The bracket according to claim 13, further comprising an axle extending through the locking body and the base, the axle defining a pivot axis for pivoting of the locking body relative to the base.

15. The bracket according to claim 1, wherein the locking body is slidable relative to the base.

16. The bracket according to claim 1, wherein the locking body and the base have at least one corresponding projection.

17. The bracket according to claim 1, wherein the opening is U-shaped.

18. The bracket according to claim 1, wherein the locking body comprises a tab extending therefrom.

19. The bracket according to claim 18, wherein the tab is located proximate to the opening.

20. The bracket according to claim 1, wherein the engagement surface comprises at least a portion of a perimeter defining the opening.

21. The bracket according to claim 1, wherein the locking body comprises a dimple and the base comprises a recess configured to receive the dimple.

22. In combination, an element and a bracket for mounting the element to a structure, the bracket comprising:
a base attachable to the structure and defining an aperture for receiving the element; and
a locking body defining an opening adapted to receive the element, the locking body defining an engagement surface positioned within the opening, the engagement surface adapted to secure the element to the base, the locking body being movable between a first position wherein the opening is not aligned with the aperture, and a second position wherein the opening aligns with the aperture, the engagement surface being engagable with the element when the locking body is in the second position.

23. The combination according to claim 22, wherein the element defines at least one recess.

24. The combination according to claim 23, wherein the engagement surface comprises at least a portion of a perimeter defining the opening.

25. The combination according to claim 24, wherein the radius of the portion of the opening is larger than a radius at the recess and smaller than the outer radius of the tube.

26. The combination according to claim 25, wherein the portion of the perimeter is receivable into a recess of the at least one recess.

27. The combination according to claim 26, wherein the element is a tube.

28. The combination according to claim 27, wherein the aperture comprises a radius larger than an outer radius of the tube.

29. The combination according to claim 28, wherein at least a portion of the opening has a radius smaller than the radius of the aperture.

30. The combination according to claim 27, wherein the aperture comprises a radius larger than a radius of at least one recess of the at least one recess and smaller than an outer radius of the tube.

31. The combination according to claim 22, wherein the opening is U-shaped.

32. A method of securing an element to a structure by a bracket, the method comprising:
positioning an element within an aperture defined by a base; and
moving a locking body from a first position to a second position, the locking body defining an opening adapted to receive the element, the locking body defining an engagement surface positioned within the opening, the engagement surface adapted to secure the element to the base,
wherein the opening is not aligned with the aperture in the first position, and
wherein the opening aligns with the aperture and the engagement surface engages with the element when the locking body is in the second position.
